(19) United States
(12) Patent Application Publication
(10) Pub. No.: US 2014/0018169 A1
(43) Pub. Date: Jan. 16, 2014

(54) Self as Avatar Gaming with Video Projecting Device

(71) Applicant: Zhong Yuan Ran, Edison, NJ (US)

(72) Inventor: Zhong Yuan Ran, Edison, NJ (US)

(21) Appl. No.: 13/941,477

(22) Filed: Jul. 13, 2013

Related U.S. Application Data
(60) Provisional application No. 61/741,263, filed on Jul. 16, 2012.

(51) Int. Cl. A63F 13/00

(52) U.S. Cl. CPC A63F 13/00
USPC 463/31

(57) ABSTRACT

Video projecting can be utilized to create an immersive environment in an typical living room, This environment can deliver immersive gaming, providing a new “in body” gaming experience, where avatar and the gamer merged as one, and extending from this merged one. For example, user can “breathing fire” to fill an environment with video of fire. This can be combined with environment control device to control temperature, moisture even scent of air to delivery multi-sense gaming experience.

### CROSS-REFERENCE

This application claims benefit of U. S. provisional patent application No. 61/741,263 filed in Jul. 16, 2012

### FIELD OF INVENTION

The present invention is related to video projecting and gaming.

### BACKGROUND OF THE INVENTION

This application seek to apply video projecting devices to create an interactive environment to delivery immersive gaming experience.

### SUMMARY OF THE INVENTION

Specifically, we will use video projecting device to create an immersive environment. This environment then can be used to provide a new “in body” gaming experience with “body extensions”, where avatar of the gamer is projected back onto the gamer, overlap with the gamer and move in sync with the gamer.

### BRIEF DESCRIPTION OF FIGS

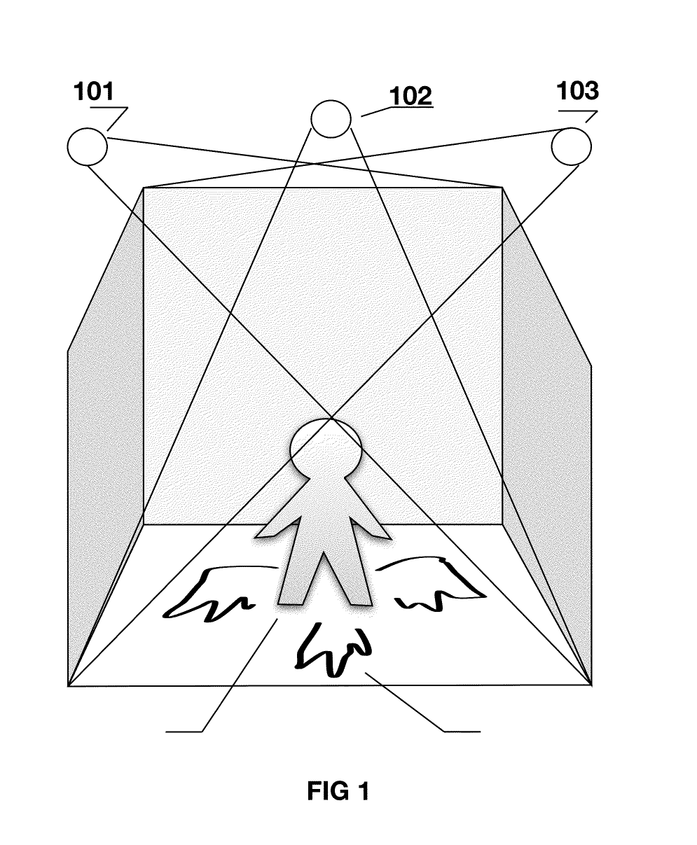

FIG. 1: an avatar of bird projected on top of an gamer, with wings can controlled by the motion of gamer's hand. The motion of the gamer is captured such that this avatar, the bird can be controlled to move in sync with the gamer and keeping the gamer and the avatar overlapping. The hand/arm motion can also be detected and the wing motion of the avatar can be kept in sync with gamer's hand/arm motion. 101, 102, 103 are projectors configured to delivery a single coherent large view angle video. 104 is the gamer, 105 is the avatar, in this case a bird, projected on the ground to overlap with the gamer.

### DETAILED DESCRIPTION OF THE INVENTION

1: Video Projecting Devices and System to Create an Encompassing Environment.

The nature of video projecting device is such that they can cover very large area of irregular surface cheaply. But to create an immersive environment, Its best to have multiple devices come together to form integrated systems that can delivery very large view angle video projection, preferably greater than 190 degree, such that a user can have an immersive experience. Multiple apertures system can be integrated into a single device. Multiple video projecting devices can form a single system, much like multiple screens for a single computer to form a single very large virtual screen.

With such system, its is very easy to have large view angle visual effects in an environment, so we can “fill the room” with specially generated video. We will use this system to delivery an immersive gaming experience.

2: Self as Avatar Gaming

In many video games, there is an avatar that a gamer can control. These avatars typically will be visualized on a screen. But for our application, we will take advantage of the natural of projecting video, to project video onto the ground where the gamer stands, on top of the gamer. The best avatar is the gamer herself. We can project the whole game scene back onto the gamer's environment in a manner to overlap game avatar with the position and orientation of the gamer, so the gamer herself is the avatar.

Typically, if we visualize the avatar, the avatar can occupy bigger space than normal human gamer, such that the extra visual elements on the ground where the gamer stands can be visualized for the gamer to see. The portion of the avatar that overlapping with human body space may or may not be visualized, (if visualized, it will be projected on top of the gamer which is not very visible to the gamer herself), But the outer edge of the avatar and surrounding scene and “body extensions(explained later)” can be visualized and projected into the environment. This will create an merged gamer/avatar experience.

With self as avatar, actions of gamers can be directly interpreted as control, these actions can be: turning, location change, body posture and posture change, hand/feet and other gesture change. Voice can also be interpreted as commands. The motion and action of the avatar can be synchronized with motion and action of the gamer.

3: Body Extensions of Avatar and Elements Interacting with Virtual Environment.

The avatar can have “extensions”. These body extensions, can be: the armors on the avatar, the long wedding dress on the avatar, or a fictitious “limbo”, like a giant hand, a “claw”, wings, a “tongue” for a lizard. On a more extended avatar, the weapons of the avatar, these extension of the avatar can be visualized. And such visualized body extensions will be projected back onto the gamer's immediate surroundings in connection with the avatar, and move in sync with gamers and gamer commands. This can create an “extended body” experience.

We can have limbos beyond normal human limbos like lizard tongue, wings, claws. But we also can have something that the nature does not have: hybrid limbos. Specifically, hand and arm movement is the most natural way to provide inputs. But natural hand and arm suffer from that fact they are too limited by reality. So to combine the naturalness of inputing, with unlimited experiences of virtual worlds, We create artificial limbos.

Specifically, the input is done by hand and arm motion. The artificial limbo looks like hand from the side connected to body (body of avatar). The motion of this artificial limbo is in sync, as much as can be with gamer hand/arm motion. When the avatar is projected back to overlap with the gamer, this artificial limbo appears to directly attached to the gamer. At the other end, we free our imagination to make this artificial limbo into anything, powerful weapons, tentacles etc. This emphasizing sense of body attachment on onside (body side), fantasy on the other end, produced this hybrid limbo.

We can synchronizing the motion of avatar with the gamer, especially the “body extensions” with the motion control action (most likely motion of hands and arms). Close syntonization is one of the most important element to generate sense of body attachment. Combined with of avatar-over-lapping gamer video projecting, We will create a new game experience. Body extensions can further include weapons, dresses, armors etc.

The avatar can have a “ride”. This ride can be an creature, fantasy or real, or an vehicle, such as spaceship. And these “rides” can be visualized and projected back in connection with this overlapping avatar.

Another interaction an avatar can have with the virtual environment is fire breathing. For example, we can have a dragon avatar, that on voice command that rhythm with “woo”, producing fire breathing. And this fire breathing in connection with avatar can be projected back in the immediate front of the gamer. Together with the voice commands to produce an “breathing fire” experience. “fire breathing” is worded as “a jet of flame” in claim. And in general a jet of any gaseous content can be done to replace such fire breathing.

4: Work With an Conventional Screen.

While projecting video devices have the advantage to cover very large area, It is hard to complete with current LCD screen for brightness and resolution in near future. So it is ideal to have these two technologies work together. We can use a conventional screen (LCD, Plasma etc.) as the central visual focus(main screen), but utilizing the peripheral space to delivery atmosphere of the video by video projecting device. This is especially easy to achieve for computer generated videos, because computer can generate 360 degree scene easily. These portion of the video that fall outside of the main screen is ideal to be projected in the peripheral as atmosphere. These atmosphere are especially useful when they form a moving background: The sense of motion is very strong if the whole environment is moving coherently and our peripheral vision is very sensitive to motion.

5: Relative Motion

While gamers move around in an environment can be interpreted as inputs, control an avatar moving around in a virtual environment. But this virtual environment can also be projected to move in the gamer's environment to create relative motion sensation. This is especially useful when using exercise machine as inputs. When a user walk on a treadmill machine, We can take the “walking” as inputs, create an avatar “walking” in sync with this user in an virtual environment, then project this scene back into the user's environment with avatar on top and overlapping with the user. This virtual world will move back from user/avatar create an relative motion sensation, with an large view angle video projecting, this relative motion sensation can be very realistic.

6: Work with Environment Control.

This system can work with environment control systems, such as air conditioners, to alter the environment electronically in accordance with the projected video contents. We can control airflow, its direction and strength, and the temperature. Further more, we can also control moisture of the air flow. we can even scent the air with scent cartridges according to the contents in the video. If the video scene if flower, we can sent the air with perfume and flow it to the user simulating natural breeze. If the virtual environment is inside an volcano, we can adjust the temperature on the high end of the normal so user can “feel the heat”. If the virtual scene is raining, we can increase the moisture of the air.

### SUMMARY

We can create an interactive environment by capturing location and location change of a gamer, interpreting this location and location change as the location and location change of an game avatar, visualizing at least part of this avatar and the virtual reality of this avatar, projecting this visualized reality back onto the ground that the gamer is on, in an manner overlapping the avatar and the gamer, and synchronizing the motion of this avatar and the motion of the gamer. This avatar can have body extensions. These body extension can be: lizard tongue, giant hand, tentacles, wing, claw and hybrid limbo. The body extension also be: weapon, armor, address, creature as ride, vehicle.

We can capture voice command from a gamer. We are specifically interested in a command that rhythm with ‘woo’, interpreting this voice command as an “blowing” action such as “fire breathing”, then visualizing a jet of flame for an “fire breathing dragon” application. As before we can visualizing the virtual reality of the avatar and this jet of flame and projecting this them back onto the ground of the gamer in an manner overlapping the location and orientation of the avatar with the gamer. And any jet of gaseous content or fluid content can be good substitute of jet of flame. We need to detecting the location of the gamer which is easy to do. We can use micro phone to capture user's voice or simply “blowing” action.

We further capture user input by exercise machine, such as treadmill, where the user can “running, riding, and exercising in a constrained space”. We translate the virtual distance and direction a user move on exercise machine as distance and direction of an avatar's motion in a virtual reality, visualizing the relative motion of this virtual reality, and projecting this virtual reality with relative motion back onto the ground of the gamer, in an manner to overlapping the location and orientation with the gamer. Again, this avatar can have body extensions, especially rides of creatures and vehicle.

Broadly, we prefer video projecting system with very large viewing angle, 190 degree or larger. We can also having airflow controlled by our systems, the direction, strength, moisture, temperature. we can even have scent that is electronically controlled by our system to delivery an multi-sense virtual reality experience.

What is claimed is:

1. a method to create an interactive environment, the method comprising:
a) capturing location and location change of a person in an environment,
b) interpreting said location and location change, as location and location change of a game avatar in a virtual reality, visualizing at least part of said avatar,
c) visualizing said virtual reality, projecting said visualized virtual reality back into said person's environment with said visualized avatar overlapping substantially with said person and said visualized avatar's location change is in sync with said person's location change.

2. method in claim 1, said avatar having body extension, visualizing said body extension.

3. method in claim 2 wherein said body extension is a member selected from a group consisting of: lizard tongue, giant hand, tentacle, wing, claw, hybrid limbo.

4. method in claim 2 wherein said body extension is a member selected from a group consisting of: armor, weapon, address, creature as ride, vehicle.

5. a method of creating an interactive game, the method comprising: capturing voice command from a user rhythm with woo, interpreting said voice command as blowing action of an avatar in a game, visualizing a jet of gaseous content according to said blowing action.

6. method in claim 5, wherein said jet of gaseous content is a jet of flame.

7. method in claim 5, the method further comprising: detecting location of said user, visualized and projecting said avatar and jet of gaseous content back into the environment of said user, such that said projected avatar and said user overlapping in location in said environment.

8. method in claim 6, the method further comprising: detecting location of said user, projecting and visualized said avatar and jet of flame back into the environment of said user, such that said avatar and said user overlapping in location in said environment.

9. a method to create an interactive environment, the method comprising:
capturing inputs by an user by an exercise machine, translating said inputs into motion of a game avatar in an virtual reality, rendering said motion of the avatar into relative motion of the virtual environment of said avatar, projecting said virtual environment back into the environment of said user such that the location of said avatar overlapping with said user.

10. method in claim 9, wherein said avatar having body extension.

11. method in claim 9, wherein said avatar riding on an member selected from a group consists of: an creature, a vehicle, said selected member is visualized and projected back into the environment of said user such that the location of said avatar overlapping with said user.

12. method in claim 1, wherein said projecting having a viewing angle greater than 190 degree for intended user.

13. method in claim 1, the method further comprising: controlling airflow generation electronically in a manner to be coherent with said virtual reality.

14. method in claim 1, the method further comprising: controlling the property of said airflow electronically in a manner to be coherent with said virtual reality, said property is a member selected from a group consisting of: temperature, moisture, scent.

15. method in claim 9, the method further comprising: controlling airflow generation electronically in a manner to be coherent with said virtual reality.

16. method in claim 9, the method further comprising: controlling the property of said airflow electronically in a manner to be coherent with said virtual reality, said property is a member selected from a group consisting of: temperature, moisture, scent.
